(19) United States
(12) Patent Application Publication
(10) Pub. No.: US 2005/0078486 A1
(43) Pub. Date: Apr. 14, 2005

(54) Automotive lighting apparatus

(75) Inventor: Shogo Kawaguchi, Wako-shi (JP)

Correspondence Address: MERCHANT & GOULD PC, P.O. BOX 2903, MINNEAPOLIS, MN, 55402-0903, US

(73) Assignee: HONDA MOTOR CO., LTD., Minato-ku (JP)

(21) Appl. No.: 10/942,295

(22) Filed: Sep. 15, 2004

(30) Foreign Application Priority Data
Oct. 14, 2003 (JP) 2003-354215
Dec. 5, 2003 (JP) 2003-407843

(51) Int. Cl. B60R 1/12

(52) U.S. Cl. 362/494

(57) ABSTRACT

An automotive lighting apparatus, wherein a mirror 18 having a reflecting surface 18a is disposed to a side of a light emitting body 15, and wherein a half mirror 21 having a reflecting surface 18a is disposed in such a manner as to face the light emitting body 15 and the reflecting surface 18a of the mirror 18, whereby part of light emitting from the light emitting body 15 is transmitted through the half mirror 21 which is disposed to face the light emitting body 15 for illumination, whereas the remainder part of the light is reflected on the reflecting surface 21a of the half mirror 21 and is then reflected further on the flat reflecting surface 18a of the mirror 18 to thereby pass through the half mirror 21. This process is repeated.

### BACKGROUND OF THE INVENTION

The present invention relates to automotive lighting apparatuses, and more particularly to a technique for making them thinner.

With automotive lighting apparatuses, it has been desired to make them thinner in order to secure as much space as possible for use as a luggage space, for example, and there has been proposed an automotive lighting apparatus which can be thinned by utilizing LEDs, for example.

[Patent Literature No. 1]

JP-A-2003-54460

In the event that the automotive lighting apparatus is thinned as described therein, however, since a feeling of deepness is lost, it is not possible to obtain a feeling of high quality.

### SUMMARY OF THE INVENTION

Consequently, an object of the invention is to provide an automotive lighting apparatus which can obtain the feeling of high quality even if the lighting apparatus is attempted to be thinned.

With a view to attaining the object, according to a first aspect of the invention, there is provided an automotive lighting apparatus, wherein a mirror (for example, a mirror 18, 38, 58 in embodiments) is disposed to a side of a light emitting body (for example, LEDs 15, 35, 55 in the embodiments), and wherein a half mirror (for example, a half mirror 21, 41, 61 in the embodiment) is disposed in such a manner as to face the light emitting body and a reflecting surface (for example, a reflecting surface 18a, 38a, 58a in the embodiments) of the mirror.

According to a second aspect of the invention, there is provided an automotive lighting apparatus as set forth in the first aspect of the invention, wherein the reflecting surface (for example, the reflecting surface 21a, 41a, 61a in the embodiments) of at least either of the mirror and the half mirror is formed into a curved surface.

According to a third aspect of the invention, there is provided an automotive lighting apparatus as set forth in the second aspect of the invention, wherein the reflecting surface (for example, the reflecting surface 21a, 41a, 61a in the embodiments) of at least either of the mirror and the half mirror is formed into a curved surface, whereas the reflecting surface (for example, the reflecting surface 18a, 38a, 58a in the embodiments) of the remainder is formed into a flat surface.

According to a fourth aspect of the invention, there is provided an automotive lighting apparatus as set forth in the third aspect of the invention, wherein the reflecting surface (for example, the reflecting surface 18a in the embodiment) of the mirror (for example, the mirror 18 in the embodiment) is formed into a flat surface, whereas the reflecting surface (for example, the reflecting surface 21a in the embodiment) of the half mirror (for example, the half mirror 21 in the embodiment) is formed into a spherical surface which protrudes toward the mirror, wherein the light emitting body (for example, the LEDs 15 in the embodiment) is formed into a shape which surrounds a predetermined range, and wherein the mirror is disposed within a range interior to the light emitting body.

According to a fifth aspect of the invention, there is provided an automotive lighting apparatus as set forth in the fourth aspect of the invention, wherein the light emitting body is provided in an annular shape.

According to a sixth aspect of the invention, there is provided an automotive lighting apparatus as set forth in the third aspect of the invention, wherein the reflecting surface (for example, the reflecting surface 38a in the embodiment) of the mirror (for example, the mirror 38 in the embodiment) is formed into a flat surface, whereas the reflecting surface (for example, the reflecting surface 41a in the embodiment) of the half mirror (for example, the half mirror 41 in the embodiment) is formed into a tubular surface which protrudes toward the mirror, wherein the light emitting body (for example, the LEDs 35 in the embodiment) is provided in two linear lines which extend in an axial direction of the reflecting surface of the half mirror, and wherein the mirror is disposed between the two lines of light emitting bodies.

According to a seventh aspect of the invention, there is provided an automotive lighting apparatus as set forth in the third aspect of the invention, wherein the reflecting surface (for example, the reflecting surface 58a in the embodiment) of the mirror (for example, the mirror 58 in the embodiment) is formed into a flat surface, whereas the reflecting surface (for example, the reflecting surface 61a in the embodiment) of the half mirror (for example, the half mirror 61 in the embodiment) is formed into a bent surface which recedes in an opposite direction to the mirror, and wherein the light emitting body (for example, the LEDs 55 in the embodiment) is provided linearly along a direction in which a kinked line in the reflecting surface of the half mirror extends, whereby the mirror is disposed in such a manner as to develop outwardly in directions which intersect at right angles with the direction in which the light emitting body extends.

According to the first aspect of the invention, part of a light emitted from the light emitting body is transmitted through the half mirror disposed to face the light emitting body for illumination, and the remainder part of the light is reflected on the reflecting surface of the half mirror so as to be reflected further on the reflecting surface of the mirror. Part of the reflected light is transmitted through the half mirror again for illumination, and the remainder part of the reflected light is reflected on the reflecting surface of the half mirror so as to be reflected further on the reflecting surface of the mirror. This process is repeated, and a plurality of virtual images appear in such a manner as to gradually spread into the distance relative to a real image of the light emitted from the light emitting body, so that a feeling of deepness is obtained. Consequently, even if the lighting apparatus is attempted to be made thinner, a feeling of high quality can be obtained, and the visibility can also be enhanced.

According to the second aspect of the invention, since the reflecting surface of at least either of the mirror and the half mirror is formed into the curved surface, the reflecting direction of the light can be changed on the curved reflecting surface. Consequently, elaborate emitting patterns can be designed.

According to the third aspect of the invention, since the reflecting surface of at least either of the mirror and the half mirror is formed into the curved surface, whereas the reflecting surface of the remainder is formed into the flat surface, a light emitting pattern can easily be set when compared with a case where the reflecting surfaces of the both mirrors are formed into a curved surface.

According to the fourth aspect of the invention, part of the light emitted from the light emitting body provided in the shape which surrounds the predetermined range is transmitted through the half mirror disposed in such a manner as to face the light emitting body for illumination, and the remainder part of the light is directed more inwardly on the convex and spherical reflecting surface of the half mirror to be reflected thereon so as to be reflected further on the reflecting surface of the mirror. Part of the reflected light is transmitted again through the half mirror for illumination, whereas the remainder part of the reflected light is directed inwardly on the convex and spherical reflecting surface of the half mirror in substantially the same manner as that described above to be reflected thereon so as to be reflected further on the flat reflecting surface of the mirror. This is repeated, and a plurality of virtual images appear which are formed into a shape which surrounds the predetermined range in such a manner as to gradually spread into the distance while becoming smaller in size inwardly in a substantially similar fashion relative to the real image of the light emitted from the light emitting body which is provided in the shape which surrounds the predetermined range, so that a clear feeling of deepness is obtained. Consequently, even if the lighting apparatus is attempted to be made thinner, a feeling of high quality can be obtained in an ensured fashion.

According to the fifth aspect of the invention, since the light emitting body is provided in the annular shape, a plurality of virtual images appear in such a manner as to gradually spread into the distance while becoming smaller in size inwardly in the substantially similar fashion relative to the light from the light emitting body provided in the annular shape. Consequently, there is no risk that a complicated impression is imparted.

According to a sixth aspect of the invention, part of light emitted from each of the light emitting bodies provided in the two straight lines is transmitted through the half mirror disposed in such a manner as to face the light emitting bodies in a straight line as a whole for illumination, whereas the remainder part of the light is directed inwardly on the convex and tubular reflecting surface of the half mirror while remaining as the straight line as a whole to be reflected thereon so as to be reflected further on the flat reflecting surface of the mirror. Part of the reflected light is transmitted again through the half mirror for illumination in a straight line as a whole, where as the remainder part of the reflected light is directed inwardly on the convex and tubular reflecting surface of the half mirror while remaining as the straight line as a whole in substantially the same manner as that described above to be reflected thereon so as to be reflected further on the flat reflecting surface of the mirror. This is repeated, and a plurality of linear virtual images appear in such a manner as to gradually spread into the distance inwardly relative to each of real images of the light emitted from the light emitting bodies provided in the two straight lines.

According to a seventh aspect of the invention, for example, part of the light emitted from the light emitting body provided linearly is transmitted through the bent portion of the half mirror disposed so as to face the light emitting body in a straight line as a whole for illumination, another part of the light is directed outwardly on one side of the bent portion of the reflecting surface of the half mirror which is bent into a concaved shape while remaining as the straight line as a whole to be reflected thereon so as to be reflected further on the flat reflecting surface of the mirror, and the remainder part of the light is directed outwardly on an opposite side of the bent portion of the reflecting surface of the half mirror which is bent into the concaved shape while remaining as the straight line as a whole to be reflected thereon so as to be reflected further on the flat reflecting surface of the mirror. Part of each reflected light is transmitted again through the half mirror in a straight line as a whole for illumination, and parts of the reflected light are directed outwardly on the reflecting surface of the half mirror in substantially the same manner as that described above while remaining as the straight line as a whole to be reflected thereon so as to be reflected further on the flat reflecting surface of the mirror. This is repeated, and a plurality of linear virtual images appear in such a manner as to gradually spread into the distance outwardly relative to each of real images of the light emitted from the light emitting bodies provide linearly, whereby a clear feeling of deepness can be obtained. Consequently, even if the lighting apparatus is attempted to be made thinner, the feeling of high quality can be obtained in an ensured fashion.

### BRIEF DESCRIPTION OF THE DRAWINGS

FIG. 1 is a perspective view as viewed from the rear of a vehicle to which an automotive lighting apparatus according to a first embodiment of the invention is applied.

FIG. 2 is a cross-sectional view of the automotive lighting apparatus according to the first embodiment of the invention.

FIG. 3 is a front view of the automotive lighting apparatus according to the first embodiment of the invention with a cover lens and a half mirror removed.

FIG. 4 is a cross-sectional view showing an optical pass of the automotive lighting apparatus according to the first embodiment of the invention.

FIG. 5 is a perspective view showing an illuminated image of the automotive lighting apparatus according to the first embodiment of the invention.

FIG. 6 is a cross-sectional view of an automotive lighting apparatus according to a second embodiment of the invention.

FIG. 7 is a front view of the automotive lighting apparatus according to the second embodiment of the invention with a cover lens and a half mirror removed.

FIG. 8 is a perspective view showing an illuminated image of the automotive lighting apparatus according to the second embodiment of the invention.

FIG. 9 is a perspective view showing an illuminated image of a modified example of the automotive lighting apparatus according to the second embodiment of the invention.

FIG. 10 is a cross-sectional view of an automotive lighting apparatus according to a third embodiment of the invention.

FIG. 11 is a front view of the automotive lighting apparatus according to the third embodiment of the invention with a cover lens and a half mirror removed.

FIG. 12 is a perspective view showing an illuminated image of the automotive lighting apparatus according to the third embodiment of the invention.

FIG. 13 is a perspective view showing an illuminated image of a modified example of the automotive lighting apparatus according to the third embodiment of the invention.

### DETAILED DESCRIPTION OF THE PREFERRED EMBODIMENTS

### First Embodiment

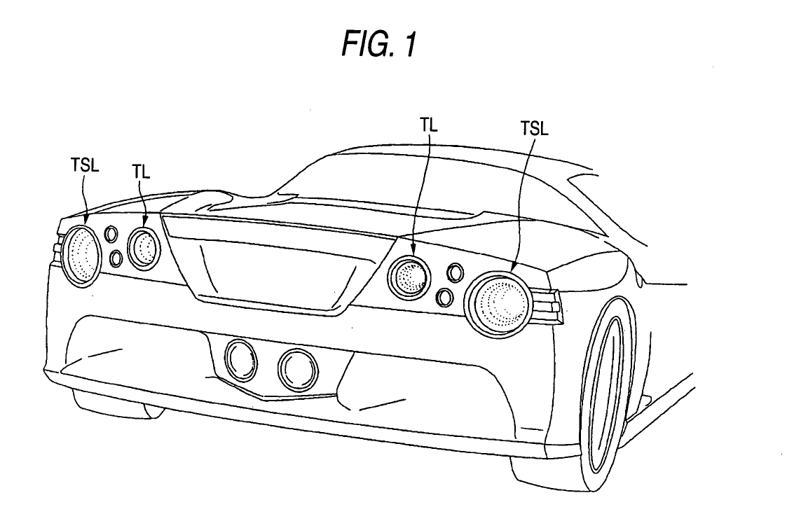

An automotive lighting apparatus according to a first embodiment of the invention will be described by reference to FIGS. 1 to 5.

FIG. 1 is a view resulting when a vehicle-is viewed from a rear end thereof, and the automotive lighting apparatus according to the embodiment is applied to tail lamps TL and tail/stop lamps TSL shown in the drawing.

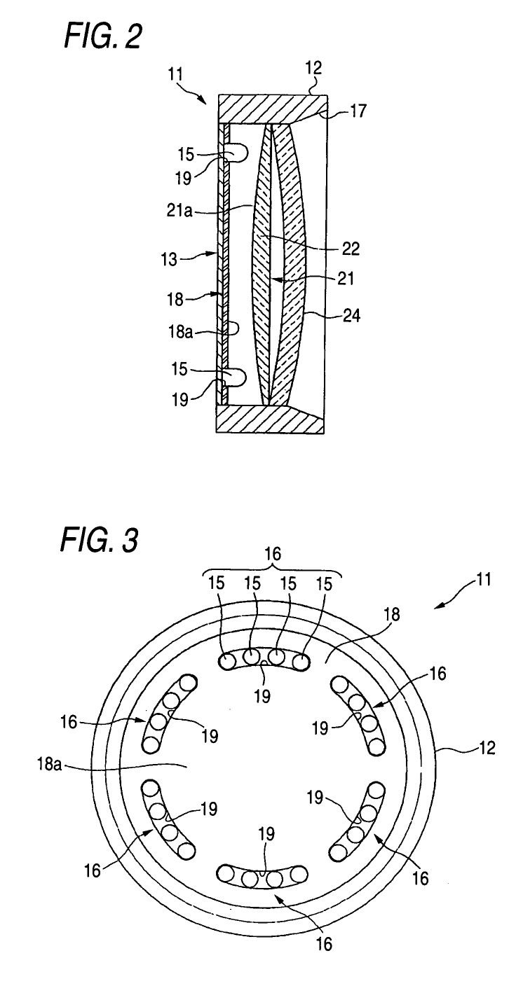

As shown in FIGS. 2 and 3, an automotive lighting apparatus 11 of the first embodiment has a case 12 which is formed into a cylindrical shape whose axial length is made shorter, and a disc-like base 13 is disposed on one of axial sides of the case 12 in such a manner as to intersect at right angles with the axis of the case 12. In addition, a plurality of LEDs (light emitting bodies) 15 are provided in a circle which is concentric with the case 12 on a side of the base 13 which faces the interior of the case 12. These LEDs 15 are all oriented toward a side opposite to the base 13 in such a manner that main light emitting directions thereof are made to extend along the axial direction of the case 12. Here, a predetermined plural number of, or, specifically speaking, four LEDs 15 are disposed at regular intervals so as to constitute a set of LEDs 16, and a predetermined plural number of, or, specifically speaking, six sets of LEDs 16 are disposed at regular intervals in such a manner as to divide a circle equally. A tapered surface 17 is formed on an inner circumferential side of an end portion of the case 12 which is situated on an opposite side of the case 12 to the base 13.

The automotive lighting apparatus 11 of the first embodiment has a circular flat mirror 18 on a side of the base 13 where the LEDs 15 are situated in the interior of the case 12. The mirror 18 has on one side thereof a flat reflecting surface 18a, which is provided in such a manner as to intersect at right angles with the axis of the case 12, and the reflecting surface 18a constitutes a mirror surface and is intended to implement a total reflection thereon. A plurality of, or, specifically speaking, six arc-like hole portions 19 are formed in the mirror 18 for each set of LEDs 16 to be inserted thereinto, and the mirror 18 is fixed concentrically to the case 12 in such a manner as to be in parallel with the base 13 with the respective sets of LEDs 16 being inserted into the hole portions 19 and the reflecting surface 18a being oriented toward an opposite side to the base 13. This allows the mirror 18 having the flat reflecting surface 18a to be disposed to the side of the LEDs 15, and furthermore, the plurality of LEDs 15 are provided in a shape which surrounds a predetermined range or, specifically speaking, an annular shape, and the mirror 18 is disposed in a range interior to the LEDs 15.

In addition, the automotive lighting apparatus 11 of the first embodiment has in the interior of the case 12 a circular, semi-transparent and semi-reflecting half mirror 21 on a side of the mirror 18 which is opposite to a side there of which faces the base 13. This half mirror 21 is such that a reflecting surface 21a is formed through aluminum deposition on a convex surface of a plano-convex lens 22 made up of a transparent glass or resin having a spherical convex surface on one of axial sides of the lens and a flat surface on the remainder opposite side thereof, and the reflecting surface 21a is formed into a spherical shape from the shape of the plano-convex lens 22. This half mirror 21 is fixed concentrically to the case 12 with the reflecting surface 21a being caused to face the plurality of LEDs 15 and the reflecting surface 18a of the mirror at a predetermined interval.

Furthermore, the automotive lighting apparatus 11 of the first embodiment has in the interior of the case 12 a circular transparent cover lens 24 on a side of the half mirror 21 which is opposite to the mirror 18. This cover lens 24 is a lens made up of a transparent glass or resin of a constant thickness in which one of axial sides thereof is formed into a spherically convex surface and the remainder opposite side thereof is formed into a spherically concave surface, and is fixed concentrically to the case 12 in such a manner as to protrude toward a side opposite to the half mirror 21. Note that the cover lens 24 may be formed into a flat plate-like shape.

This allows the case 12, the base 13, the mirror 18, the half mirror 21 and the cover lens 24 to be provided concentrically, and the LEDs 15 are also disposed in an annular fashion on the circle concentric with the respective members. Then, the automotive lighting apparatus 11 is attached to a vehicle body in a posture in which the cover lens 24 is oriented toward the rear of the vehicle body, that is, in a posture in which the main light emitting directions of the LEDs 15 are oriented toward the outside of the vehicle body.

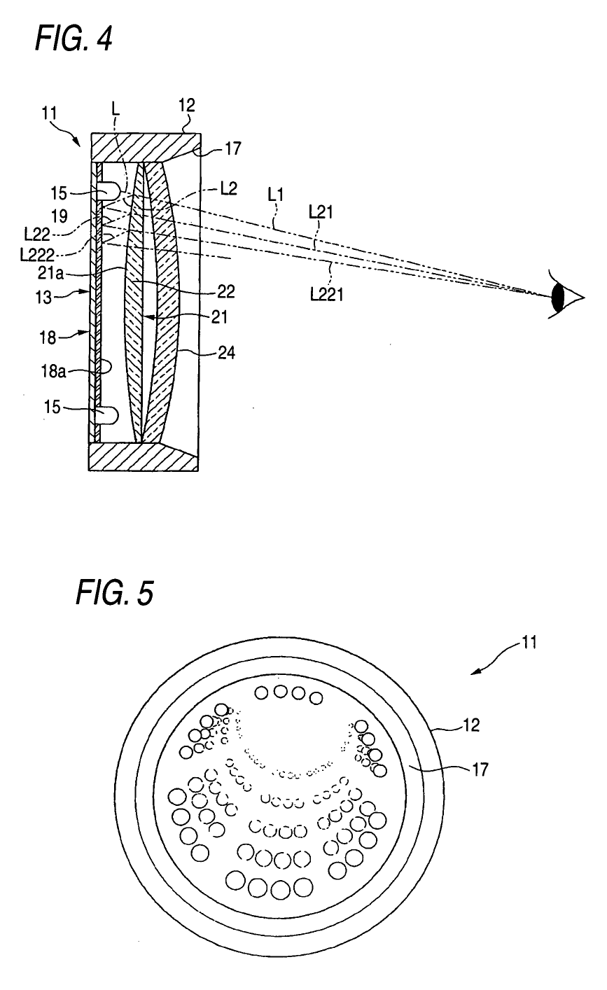

According to the automotive lighting apparatus 11 of the first embodiment that has been described heretofore, as shown in FIG. 4, part L1 of a light L emitted from each of the LEDs 15 disposed in such a manner as to surround the predetermined range in the annular fashion is transmitted through the half mirror 21 for illumination outside the vehicle. In addition, the remainder part L2 of the light L is directed inwardly on the convex reflecting surface 21a of the half mirror 21 to be reflected thereon so as to be reflected further on the flat reflecting surface 18a of the mirror 18, and the light L2 has a longer optical path length than that of the light L1 which is transmitted through the half mirror 21. Then, part L21 of the reflected light L2 is transmitted through the half mirror 21 for illumination outside the vehicle, whereas the remainder part L22 of the reflected light L2 is directed inwardly in substantially the same manner as that described above on the convex reflecting surface 21a of the half mirror 21 to be reflected thereon so as to be reflected further on the flat reflecting surface 18a of the mirror 18. Then, part L221 of the reflected light L22 is transmitted through the half mirror 21 for illumination outside the vehicle, whereas the remainder part L222 of the reflected light L22 is directed inwardly in substantially the same manner as that described above on the convex reflecting surface 21a of the half mirror 21 to be reflected thereon so as to be reflected further on the flat reflecting surface 18a of the mirror 18. This is repeated, and as shown in FIG. 5, a plurality of annular virtual images appear in such a manner as to gradually increasing the distance and to gradually reduce the quantity of light while becoming small in size inwardly in a substantially similar fashion relative to a real image of the light from the LEDs 15 which are provided annularly, whereby a clear feeling of deepness can be obtained. Consequently, even if the lighting apparatus is attempted to be made thinner, the feeling of high quality can be obtained in an ensured fashion, and the visibility can be enhanced. In particular, since the plurality of LEDs 15 are disposed in the annular shape, a plurality of annular virtual images appear relative to the light from these LEDs 15 in such a manner as to gradually spread into the distance while becoming small in size inwardly in the substantially similar fashion. Consequently, there is also no risk that a complicated impression is imparted. Note that since the refraction of the lenses 22, 24 has a substantially similar effect on the respective lights L1, L21, L221, the same effect on the relationship between the respective images can be ignored. FIG. 4 is illustrated without considering the effect of the refraction of the lenses as a matter of conveniences in description.

Note that while the half mirror 21 having the spherically convex reflecting surface 21a is disposed so as to face the LEDs 15 and the mirror 18 having the flat reflecting surface 18a in the embodiment, the reflecting surface 18a of the mirror 18 and the reflecting surface 21a of the half mirror 21 may be either flat or spherical. However, it is good that at least either of the two reflecting surfaces is formed into the spherical surface, and for example, a half mirror having a spherically concave reflecting surface may be disposed so as to face the LEDs 15 and the mirror 18 having the flat reflecting surface 18a. In this case, the mirror 18 is disposed outside the LEDs 15 which are provided in the shape which surrounds the predetermined range, whereby a plurality of virtual images which surround the predetermined range appear in such a manner as to gradually spread into the distance while becoming smaller in size outwardly in a substantially similar fashion relative to a real image of light from the LEDs 15. In addition, a light emitting body which itself is formed into an annular shape may be used instead of disposing the LEDs 15 in the annular shape. Furthermore, an angular shape such as triangle and quadrangle may be used for the arrangement of LEDs 15 and the shape of the light emitting body itself.

The reflecting surface 18a of the mirror 18 and the reflecting surface 21a of the half mirror may be formed into either a curved surface which is either curved or bent to provide spherical and tubular surfaces or a flat surface. As this occurs, in the event that at least either of the reflecting surface 18a of the mirror 18 and the reflecting surface 21a of the half mirror 21 is formed into a curved surface which is either curved or bent to provide spherical and tubular surfaces, since the reflecting direction of light can be changed on the curved surface, elaborate light emitting patterns can be designed. Furthermore, in the event that either of the reflecting surface 18a of the mirror 18 and the reflecting surface 21a of the half mirror 21 is formed into a curved surface, whereas the remainder is formed into a flat surface, a light emitting pattern can easily be set when compared with a case where both the reflecting surfaces are formed into a curved surface.

### Second Embodiment

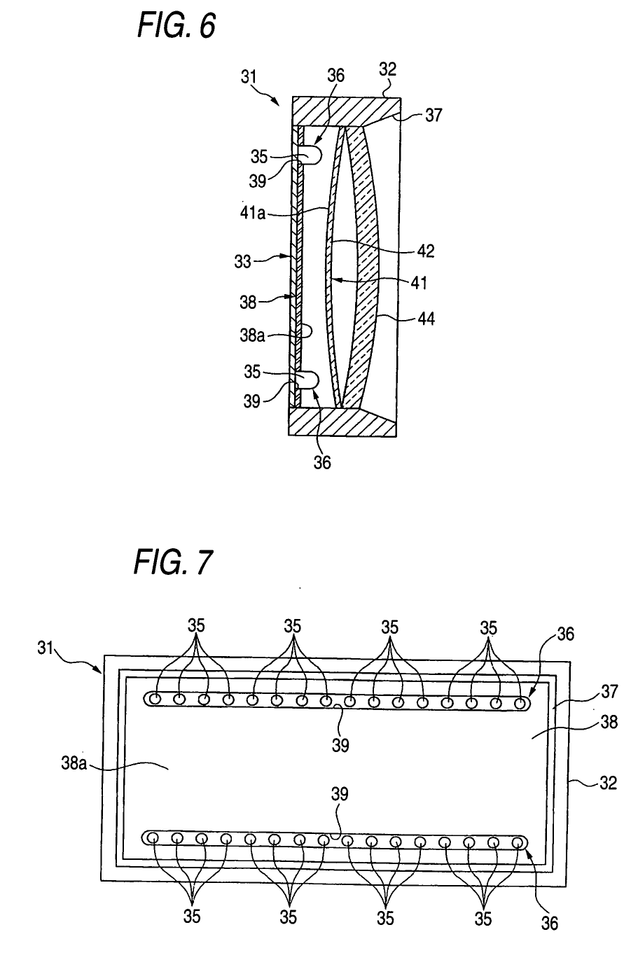

An automotive lighting apparatus according to a second embodiment of the invention will be described by reference to FIGS. 6 to 9.

An automotive lighting apparatus 31 of the second embodiment is also such as to be applied to tail lamps and tail/stop lamps.

The automotive lighting apparatus 31 of the second embodiment has a case 32 which is formed into a rectangular parallelepiped-like, horizontally elongated shape whose axial length is made shorter, and a horizontally elongated, rectangular plate-like base 33 is disposed on one of axial sides of the case 32 in such a manner as to intersect at right angles with the axis of the case 32. In addition, a plurality of LEDs (light emitting bodies) 35 are provided on a side of the base 33 which faces the interior of the case 32 along top and bottom edges in a width direction thereof, respectively, in such a manner as to be arranged in line horizontally and longitudinally of the case 32 at regular intervals. Namely, two LED lines 36 each having a plurality of LEDs 35 arranged in line are provided in parallel in a vertical direction, which is the length direction of the case 32. These LEDs 35 are all oriented toward a side opposite to the base 33 in such a manner that main light emitting directions thereof are made to extend along the axial direction of the case 32. An inclined surface 37 is formed on an inner side of an end portion of the case 32 which is situated on an opposite side of the case 32 to the base 33.

The automotive lighting apparatus 31 of the second embodiment has a horizontally elongated, quadrangular flat plate-like mirror 38 on a side of the base 33 where the LEDs 35 are situated in the interior of the case 32. The mirror 38 has on one side thereof a flat reflecting surface 38a, which is provided in such a manner as to intersect at right angles with the axis of the case 32, and the reflecting surface 38a constitutes a mirror surface and is intended to implement a total reflection thereon. Two linear hole portions 39 are formed in the mirror 38 for each of the LED lines 36 to be inserted thereinto, and the mirror 38 is fixed to the case 13 in such a manner as to be in parallel with the base 33 with the respective LED lines 36 being inserted into the hole portions 39 and the reflecting surface 38a being oriented toward an opposite side to the base 33. This allows the mirror 38 having the flat reflecting surface 38a to be disposed to the side of the LEDs 35, and furthermore, the plurality of LEDs 35 are provided in the two lines, and the mirror 38 is disposed between the two LED lines 36.

In addition, the automotive lighting apparatus 31 of the second embodiment has in the interior of the case 32 a horizontally elongated, quadrangular, semi-transparent and semi-reflecting half mirror 41 on a side of the mirror 38 which is opposite to a side thereof which faces the base 33. This half mirror 41 is such that a reflecting surface 41a is formed through aluminum deposition on a convex surface of a cylindrical lens 42 made up of a transparent glass or resin having a tubular convex surface on one of sides of the lens in a thickness direction thereof and a tubular concave surface on the remainder opposite side thereof, and the reflecting surface 41a is formed into a tubular surface from the shape of the cylindrical lens 42. This half mirror 41 is fixed to the case 32 with the reflecting surface 41a being caused to face the plurality of LEDs 35 and the reflecting surface 38a of the mirror 38 at a predetermined interval in a state where an axis thereof is disposed in a longitudinal direction which is a direction in which the each LED line 36 extends and at a position which is equidistant from the respective LED lines 36. This allows the LEDs 35 to be provided linearly in the two lines which extend along the axis of the reflecting surface 41a of the half mirror 41, and the mirror 38 is disposed between these two lines of LEDs 35.

Furthermore, the automotive lighting apparatus 31 of the second embodiment has in the interior of the case 32 a horizontally elongated quadrangular transparent cover lens 44 on a side of the half mirror 41 which is opposite to the mirror 38. This cover lens 44 is a lens made up of a transparent glass or resin of a constant thickness in which one of axial sides thereof is formed into a tubular convex surface and the remainder opposite side thereof is formed into a tubular concave surface, and is fixed concentrically to the case 32 in such a manner as to protrude toward a side opposite to the half mirror 41. Note that the cover lens 44 may be formed into a flat plate-like shape.

Then, the automotive lighting apparatus 31 of the second embodiment is attached to a vehicle body in a posture in which the cover lens 44 is oriented toward the rear of the vehicle body, that is, in a posture in which the main light emitting directions of the LEDs 35 are oriented toward the outside of the vehicle body.

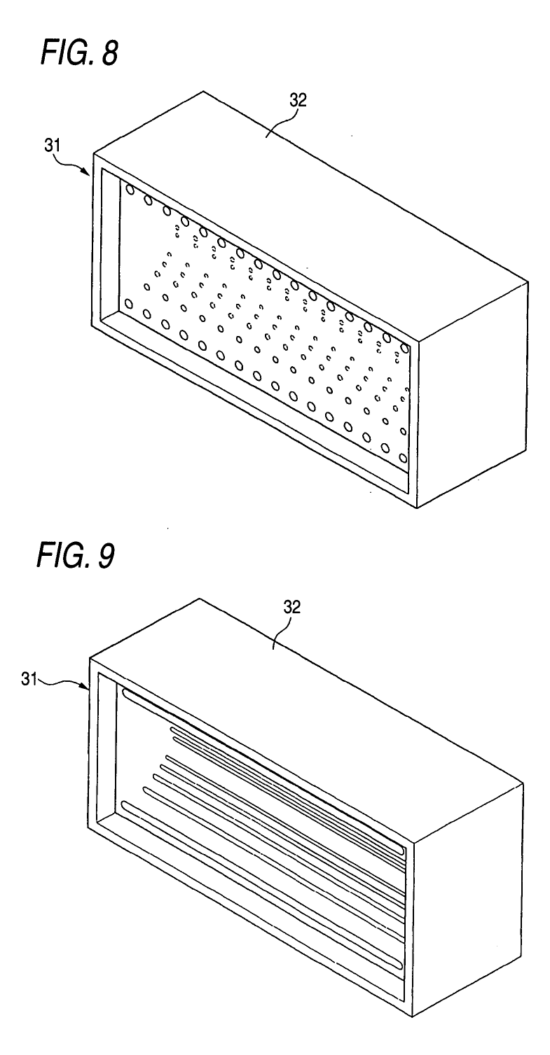

According to the automotive lighting apparatus 31 of the second embodiment that has been described heretofore, part of light emitted from each of the light emitting bodies provided in the two straight lines is, when describing about each LED line 36, transmitted through the half mirror 41 disposed in such a manner as to face the light emitting bodies for illumination in a straight line as a whole, whereas the remainder part of the light is directed inwardly on the convex and tubular reflecting surface 41a of the half mirror 41 while remaining as the straight line as a whole to be reflected thereon so as to be reflected further on the flat reflecting surface 38 a of the mirror 38. Part of the reflected light is transmitted again through the half mirror 41 for illumination in a straight line as a whole, whereas the remainder part of the reflected light is directed inwardly on the convex and tubular reflecting surface 41a of the half mirror 41 while remaining as the straight line as a whole in substantially the same manner as that described above to be reflected thereon so as to be reflected further on the flat reflecting surface 38a of the mirror 38. This is repeated, and as shown in FIG. 8, a plurality of linear virtual images appear in such a manner as to gradually spread into the distance inwardly relative to each of real images of the light emitted from the LEDs 35 which are provided in the two straight lines, and a clear feeling of deepness can be obtained. Consequently, even if the lighting apparatus is attempted to be made thinner, a feeling of high quality can be obtained in an ensured fashion, and the visibility can be enhanced. In particular, since the plurality of LEDs 35 are disposed in the two straight lines, the plurality of linear virtual images appear relative to light from the two straight LED lines 36 in such a manner as to gradually spread into the distance while deviating inwardly. Consequently, there is caused no risk that a complicated impression is imparted.

Note that in the second embodiment, the light emitting body is not limited to the LEDs 35 but light emitting bodies in any other forms may be utilized. In addition, instead of disposing the plurality of LEDs 35 in the straight line, a light emitting body which itself is formed into a linear shape may be used, and in this case, images shown in FIG. 9 will appear.

### Third Embodiment

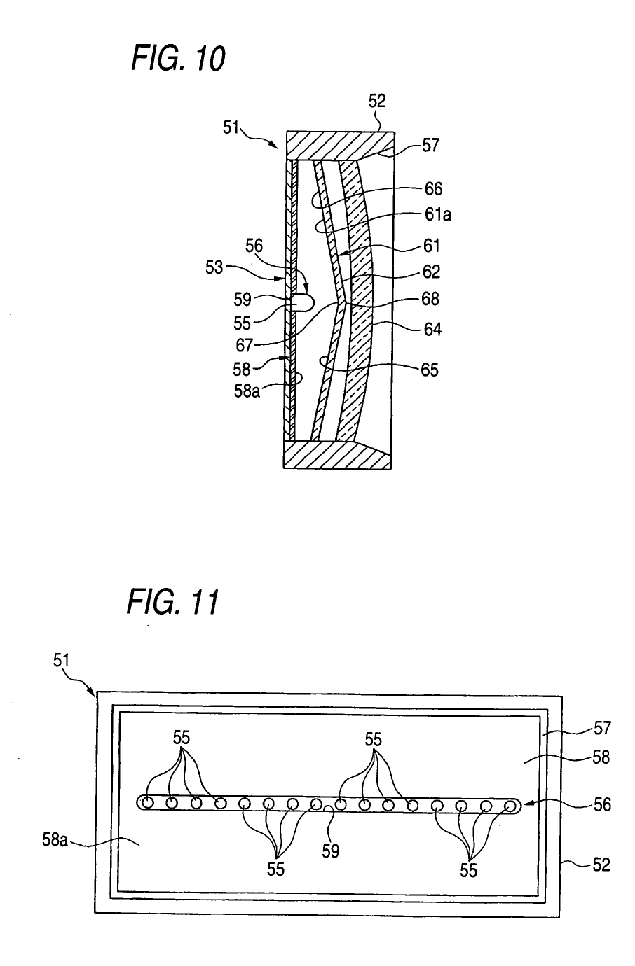

An automotive lighting apparatus according to a third embodiment of the invention will be described below by reference to FIGS. 10 to 13.

An automotive lighting apparatus 51 of the third embodiment is also such as to be applied to tail lamps and tail/stop lamps.

The automotive lighting apparatus 51 of the third embodiment has a case 52 which is formed into a rectangular parallelepiped-like, horizontally elongated shape whose axial length is made shorter, and a horizontally elongated, rectangular plate-like base 53 is disposed on one of axial sides of the case 52 in such a manner as to intersect at right angles with the axis of the case 52. In addition, a plurality of LEDs (light emitting bodies) 55 are provided on a side of the base 53 which faces the interior of the case 52 at a center between vertical top and bottom edges in a width direction thereof in such a manner as to be arranged in line horizontally and longitudinally of the case 52 at regular intervals. Namely, an LED line 56 having a plurality of LEDs 55 arranged in line is provided at the center in the vertical direction, which is the length direction of the case 52. These LEDs 55 are all oriented toward a side opposite to the base 53 in such a manner that main light emitting directions thereof are made to extend along the axial direction of the case 52. An inclined surface 57 is formed on an inner side of an end portion of the case 52 which is situated on an opposite side of the case 52 to the base 53.

The automotive lighting apparatus 51 of the third embodiment has a horizontally elongated, quadrangular flat plate-like mirror 58 on a side of the base 53 where the LEDs 55 are situated in the interior of the case 52. The mirror 58 has on one side thereof a flat reflecting surface 58a, which is provided in such a manner as to intersect at right angles with the axis of the case 52, and the reflecting surface 58a constitutes a mirror surface and is intended to implement a total reflection thereon. A linear hole portion 59 is formed in the mirror 58 for the plurality of LEDs 55 to be inserted thereinto, and the mirror 58 is fixed to the case 53 in such a manner as to be in parallel with the base 53 with the LED line 56 being inserted into the hole portions 59 and the reflecting surface 58a being oriented toward an opposite side to the base 53. This allows the mirror 58 having the flat reflecting surface 58a to be disposed to the side of the LEDs 55. Furthermore, the plurality of LEDs 55 are provided in the straight line, and the mirror 58 is disposed on both sides of the straight LED line 56 made up of the plurality of LEDs 55 which intersect at right angles with a direction in which the straight LED line 56 extends.

In addition, the automotive lighting apparatus 51 of the third embodiment has in the interior of the case 52 a horizontally elongated, quadrangular, semi-transparent and semi-reflecting half mirror 61 on a side of the mirror 58 which is opposite to a side thereof which faces the base 53. This half mirror 61 is such that a reflecting surface 61a is formed through aluminum deposition on a concave surface of a curved lens 62 made up of a transparent glass or resin having a convex curved shape formed on one of sides of the lens in a thickness direction thereof by combining two planes in an angular fashion and a concave curved shape formed on the remainder opposite side thereof by combining two planes in a groove-like fashion, and the reflecting surface 61a is formed into a curved concave shape by combining two planes 65, 66 in an angular fashion. This half mirror 61 is fixed to the case 52 with the reflecting surface 61a being caused to face the plurality of LEDs 55 and the reflecting surface 68a of the mirror 68 at a predetermined interval in a state where a boundary line between the two planes 65, 66, that is, a kinked line 67 is disposed in the longitudinal direction, which is a direction in which the LED line 56 extends and the kinked line 67 is disposed on a line which extends perpendicularly from the LED line 56 relative to the mirror 58. This allows the LEDs 55 to be provided linearly in the line which extend along the kinked line 67 in the reflecting surface 61a of the half mirror 61.

Furthermore, the automotive lighting apparatus 51 of the third embodiment has in the interior of the case 52 a horizontally elongated quadrangular transparent cover lens 64 on a side of the half mirror 61 which is opposite to the mirror 58. This cover lens 64 is a lens made up of a transparent glass or resin of a constant thickness in which one of axial sides thereof is formed into a tubular convex surface and the remainder opposite side thereof is formed into a tubular concave surface, and is fixed concentrically to the case 52 in such a manner as to protrude toward a side opposite to the half mirror 61. Note that the cover lens 64 may be formed into a flat plate-like shape.

Then, the automotive lighting apparatus 51 of the third embodiment is attached to the vehicle body in a posture in which the cover lens 64 is oriented toward the rear of the vehicle body, that is, in a posture in which the main light emitting directions of the LEDs 55 are oriented toward the outside of the vehicle body.

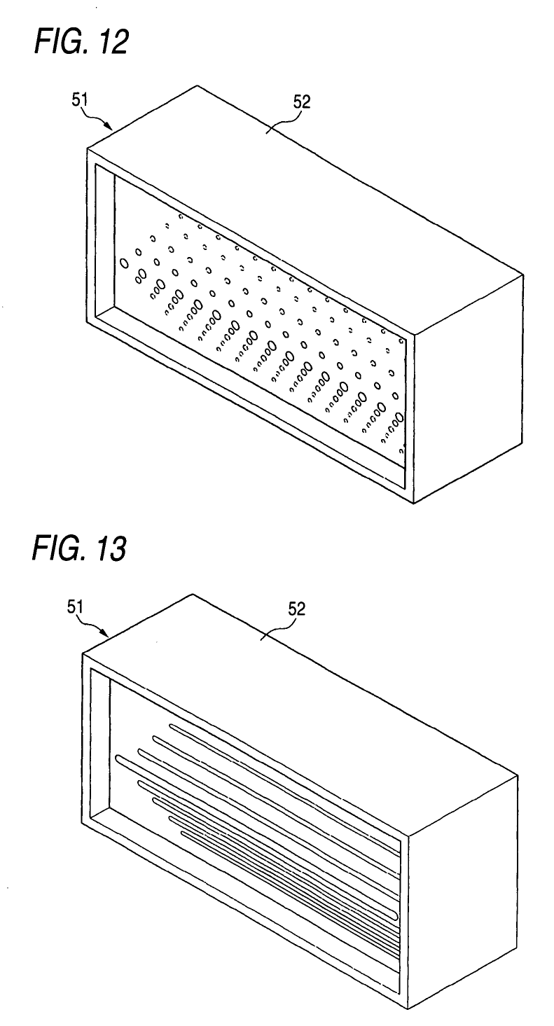

According to the automotive lighting apparatus 51 of the third embodiment that has been described heretofore, for example, part of the light emitted from the LEDs 55 which are provided linearly is transmitted in a straight line as whole through a bent portion 68 where the kinked line 67 of the half mirror 61 disposed so as to face the LEDs 55 exits for illumination, another part of the light is directed to one side on a plane 65 which constitute one side of the bent portion 68 of the reflecting surface 61a of the half mirror 61 which is bent into a concaved shape while remaining as the straight line as a whole to be reflected thereon so as to be reflected further on the flat reflecting surface 58a of the mirror 58, and the remainder part of the light is directed to an opposite side on a plane 66 which constitutes an opposite side of the bent portion 68 of the reflecting surface 61a of the half mirror 61 which is bent into the concave shape while remaining as the straight line as a whole to be reflected thereon so as to be reflected further on the flat reflecting surface 58a of the mirror 58. Part of each reflected light is transmitted again through the half mirror 61 in a straight line as a whole for illumination, and parts of the reflected light are reflected on the reflecting surface 61a of the half mirror 61 while remaining as the straight line as a whole so as to be reflected further on the flat reflecting surface 58a of the mirror 58. This is repeated, and as shown in FIG. 12, a plurality of linear virtual images appear in such a manner as to gradually spread into the distance outwardly relative to each of real images of the light emitted from the linearly provided LEDs 55, whereby a clear feeling of deepness can be obtained. Consequently, even if the lighting apparatus is attempted to be made thinner, the feeling of high quality can be obtained in an ensured fashion. In particular, since the plurality of LEDs 55 are disposed in the single straight line, a plurality of linear virtual images appear relative to the light from the straight line of LEDs 55 in such a manner as to gradually spread into the distance while gradually deviating to both the sides. Consequently, there is caused no risk that a complicated impression is imparted.

Note that in the third embodiment, the light emitting body is not limited to the LEDs 55 but light emitting bodies in any other forms may be utilized. In addition, instead of disposing the plurality of LEDs 55 in the straight line, a light emitting body which itself is formed into a linear shape may be used, and in this case, images shown in FIG. 13 will appear.

The automotive lighting apparatuses according to the first to third embodiments that have been described heretofore can be applied to any of automotive lighting apparatuses such as back-up lamps, head lamps and cornering lamps, the latter two lamps being provided at the front of a vehicle, in addition to tail lamps TL and tail/stop lamps TSL, which are both provided at the rear of the vehicle.

1. An automotive lighting apparatus, comprising:
a mirror disposed to a side of a light emitting body, and
a half mirror disposed in such a manner as to face the light emitting body and a reflecting surface of the mirror.

2. The automotive lighting apparatus as set forth in claim 1, wherein
the reflecting surface of at least either of the mirror and the half mirror is formed into a curved surface.

3. The automotive lighting apparatus as set forth in claim 2, wherein
the reflecting surface of either of the mirror and the half mirror is formed into a curved surface, and
the reflecting surface of the remainder thereof is formed into a flat surface.

4. The automotive lighting apparatus as set forth in claim 3, wherein
the reflecting surface of the mirror is formed into a flat surface,
the reflecting surface of the half mirror is formed into a spherical surface which protrudes toward the mirror,
the light emitting body is formed into a shape which surrounds a predetermined range, and
the mirror is disposed within a range interior to the light emitting body.

5. The automotive lighting apparatus as set forth in claim 4, wherein
the light emitting body is provided in an annular shape.

6. The automotive lighting apparatus as set forth in claim 3, wherein
the reflecting surface of the mirror is formed into a flat surface,
the reflecting surface of the half mirror is formed into a tubular surface which protrudes toward the mirror,
the light emitting body is provided in two linear lines which extend in an axial direction of the reflecting surface of the half mirror, and
the mirror is disposed between the two lines of light emitting bodies.

7. The automotive lighting apparatus as set forth in claim 3, wherein
the reflecting surface of the mirror is formed into a flat surface,
the reflecting surface of the half mirror is formed into a bent surface which recedes in an opposite direction to the mirror,
the light emitting body is provided linearly along a direction in which a kinked line in the reflecting surface of the half mirror extends, and
the mirror is disposed in such a manner as to develop outwardly in directions which intersect at right angles with the direction in which the light emitting body extends.
